(19) United States
(12) Patent Application Publication
(10) Pub. No.: US 2015/0235321 A1
(43) Pub. Date: Aug. 20, 2015

(54) INSURANCE RISK MODELING METHOD AND APPARATUS

(71) Applicant: MASTERCARD INTERNATIONAL INCORPORATED, Purchase, NY (US)

(72) Inventors: Kenny UNSER, Fairfield, CT (US); Serge BERNARD, Danbury, CT (US); Nikhil MALGATTI, Stamford, CT (US); Jean-Pierre GERARD, Croton-On-Hudson, NY (US); Po HU, Norwalk, CT (US)

(73) Assignee: MASTERCARD INTERNATIONAL INCORPORATED, Purchase, NY (US)

(21) Appl. No.: 14/183,220

(22) Filed: Feb. 18, 2014

(51) Int. Cl. G06Q 40/08

(52) U.S. Cl. CPC G06Q 40/08; G06Q 40/025

(57) ABSTRACT

A system, method, and computer-readable storage medium configured to enable insurance-related risk behavior modeling of individuals based on their payment card purchases.

### BACKGROUND

1. Field of the Disclosure

Aspects of the disclosure relate in general to data mining financial services. Aspects include an apparatus, system, method and computer-readable storage medium to enable insurance-related risk behavior modeling of individuals based on their payment card purchases.

2. Description of the Related Art

The use of payment cards, such as credit or debit cards, is ubiquitous in commerce. Typically, a payment card is electronically linked via a payment network to an account or accounts belonging to a cardholder. These accounts are generally deposit accounts, loan or credit accounts at an issuer financial institution. During a purchase transaction, the cardholder can present the payment card in lieu of cash or other forms of payment.

Payment networks process trillions of purchase transactions by cardholders. The data from the purchase transactions can be used to analyze cardholder behavior. Typically, the transaction level data can be used only after it is summarized up to customer level. Unfortunately, the current transaction rolled-up processes are pre-knowledge based and does not result in transaction level models. For example, a merchant category code (MCC) or industry sector are to classify purchase transactions and summarize transactions in each category. This kind of summarization of information is a generic approach without using target information.

### SUMMARY

Embodiments include a system, apparatus, device, method and computer-readable medium configured to enable insurance-related risk behavior modeling of individuals based on their payment card purchases.

In a risk assessment embodiment, transaction data regarding a financial transaction is received. The transaction data includes a transaction attribute. A processor generates a customer level target specific variable layer from the transaction data. The processor models cardholder behavior with the customer level target specific variable layer to create a risk model of cardholder behavior. The risk model of cardholder behavior is saved to a non-transitory computer-readable storage medium.

### BRIEF DESCRIPTION OF THE DRAWINGS

FIG. 1 illustrates an embodiment of a system configured to enable insurance-related risk behavior modeling of individuals based on their payment card purchases.

FIG. 2 depicts a data flow diagram of a risk assessment apparatus configured to enable insurance-related risk behavior modeling of individuals based on their payment card purchases.

### DETAILED DESCRIPTION

One aspect of the disclosure includes the realization that a purchase behavior is a powerful source of information that complements demographics and self-reported preferences to create a complete profile of an individual's lifestyle.

Another aspect of the disclosure includes the understanding that analyzing cardholder spending provides a source of predictive information that may be used for insurance purposes. For example, frequent cardholder may indicate propensity for risky behavior or other drivers of life expectancy. Similarly, frequent service visits to auto-repair shops may be indicators for cardholder driving. Conversely, frequent purchases at health-food stores may indicate the likelihood of cardholder longevity. These and other similar cardholder purchases and expenditures may contain predictive information for the development of a cardholder transaction level risk model.

Yet another aspect of the disclosure is the realization that a cardholder transaction level risk model may be applied to the likelihood of risk for insurance purposes.

Embodiments of the present disclosure include a system, method, and computer-readable storage medium configured to enable insurance-related risk behavior modeling of individuals based on their payment card purchases. For the purposes of this disclosure, a payment card includes, but is not limited to: credit cards, debit cards, prepaid cards, electronic checking, electronic wallet, or mobile device payments.

Embodiments may be used in a variety of potential insurance applications, including underwriting, identifying inconsistencies (determining deductibles not paid, or purchases not aligned with insurance payouts associated with the purchased items, and the like), claims estimation, and identification of events that may include policy services. Example of event identification that may be determined by embodiments include life stage events, purchase of insurable goods, and changes in the number of miles driven on a vehicle (using gas purchases as a proxy).

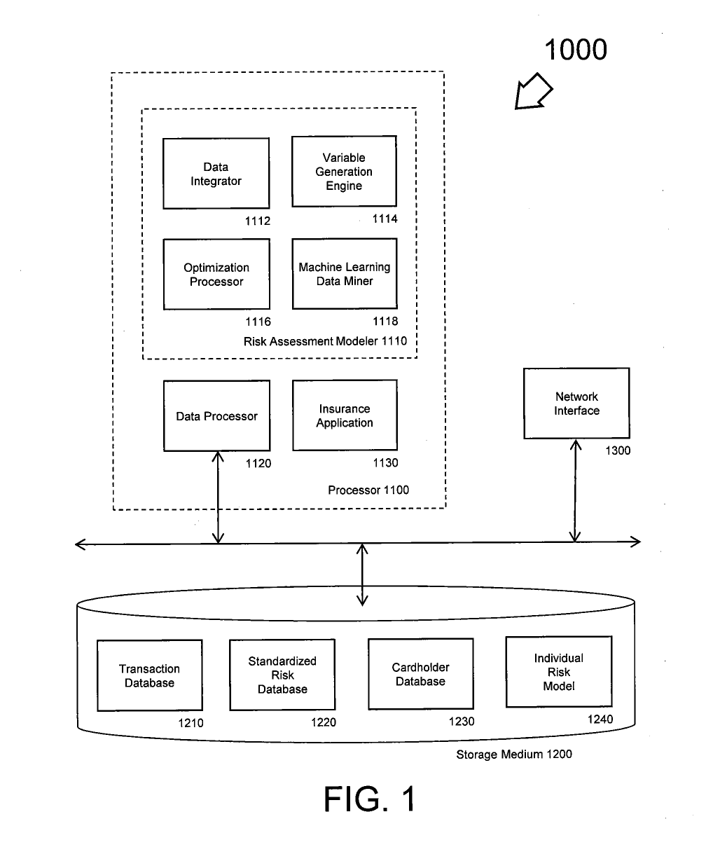

Embodiments will now be disclosed with reference to a block diagram of an exemplary risk assessment apparatus server 1000 of FIG. 1 configured to enable insurance-related risk behavior modeling of individuals based on their payment card purchases, constructed and operative in accordance with an embodiment of the present disclosure.

Risk assessment apparatus server 1000 may run a multi-tasking operating system (OS) and include at least one processor or central processing unit (CPU) 1100, a non-transitory computer-readable storage medium 1200, and a network interface 1300. An example operating system may include Advanced Interactive Executive (AIX™) operating system, UNIX operating system, or LINUX operating system, and the like.

Processor 1100 may be any central processing unit, microprocessor, micro-controller, computational device or circuit known in the art. It is understood that processor 1100 may communicate with and temporarily store information in Random Access Memory (RAM) (not shown).

As shown in FIG. 1, processor 1100 is functionally comprised of a risk assessment modeler 1110, an insurance application 1130, and a data processor 1120.

Risk assessment modeler 1110 is a component configured to perform risk estimation by analyzing financial transactions. Risk assessment modeler 1110 may further comprise: a data integrator 1112, variable generation engine 1114, optimization processor 1116, and a machine learning data miner 1118.

Data integrator 1112 is an application program interface (API) or any structure that enables the risk assessment modeler 1110 to communicate with, or extract data from, a database.

Variable generation engine 1114 is any structure or component capable of generating customer level target-specific variable layers from given transaction level data.

Optimization processor 1116 is any structure configured to receive target variables from a transaction level model defined from a business application and refine the target variables.

Machine learning data miner 1118 is a structure that allows users of the risk assessment modeler 1110 to enter, test, and adjust different parameters and control the machine learning speed. In some embodiments, machine learning data miner uses decision tree learning, association rule learning, neural networks, inductive logic programming, support vector machines, clustering, Bayesian networks, reinforcement learning, representation learning, similarity and metric learning, spare dictionary learning, and ensemble methods such as random forest, boosting, bagging, and rule ensembles, or a combination thereof.

Insurance application 1130 is an application that performs risk estimation by utilizing bureau information and risk assessment modeler 1110.

Data processor 1120 enables processor 1100 to interface with storage media 1200, network interface 1300 or any other component not on the processor 1100. The data processor 1120 enables processor 1100 to locate data on, read data from, and write data to these components.

These structures may be implemented as hardware, firmware, or software encoded on a computer readable medium, such as storage media 1200. Further details of these components are described with their relation to method embodiments below.

Network interface 1300 may be any data port as is known in the art for interfacing, communicating or transferring data across a computer network, examples of such networks include Transmission Control Protocol/Internet Protocol (TCP/IP), Ethernet, Fiber Distributed Data Interface (FDDI), token bus, or token ring networks. Network interface 1300 allows risk assessment apparatus server 1000 to communicate with vendors, cardholders, and/or issuer financial institutions.

Computer-readable storage media 1200 may be a conventional read/write memory such as a magnetic disk drive, floppy disk drive, optical drive, compact-disk read-only-memory (CD-ROM) drive, digital versatile disk (DVD) drive, high definition digital versatile disk (HD-DVD) drive, Blu-ray disc drive, magneto-optical drive, optical drive, flash memory, memory stick, transistor-based memory, magnetic tape or other computer-readable memory device as is known in the art for storing and retrieving data. Significantly, computer-readable storage media 1200 may be remotely located from processor 1100, and be connected to processor 1100 via a network such as a local area network (LAN), a wide area network (WAN), or the Internet.

In addition, as shown in FIG. 1, storage media 1200 may also contain a transaction database 1210, standardized risk database 1220, cardholder database 1230 and an individual risk model 1240. Transaction database 1210 is configured to store records of payment card transactions. Standardized risk database 1220 is configured to store standardized insurance risk information; in some embodiments, the standardized risk database 1220 may also contain information about independent risk variables and insurance pricing information. Cardholder database 1230 is configured to store cardholder information and transactions information related to specific cardholders. In some embodiments, cardholder database 1230 may be the transaction database 1210 organized by cardholder information. An individual risk model 1240 is a risk model for a cardholder based on cardholder transactions. In some embodiments, an individual cardholder's transactions may be compared to transactions made by other cardholder transactions.

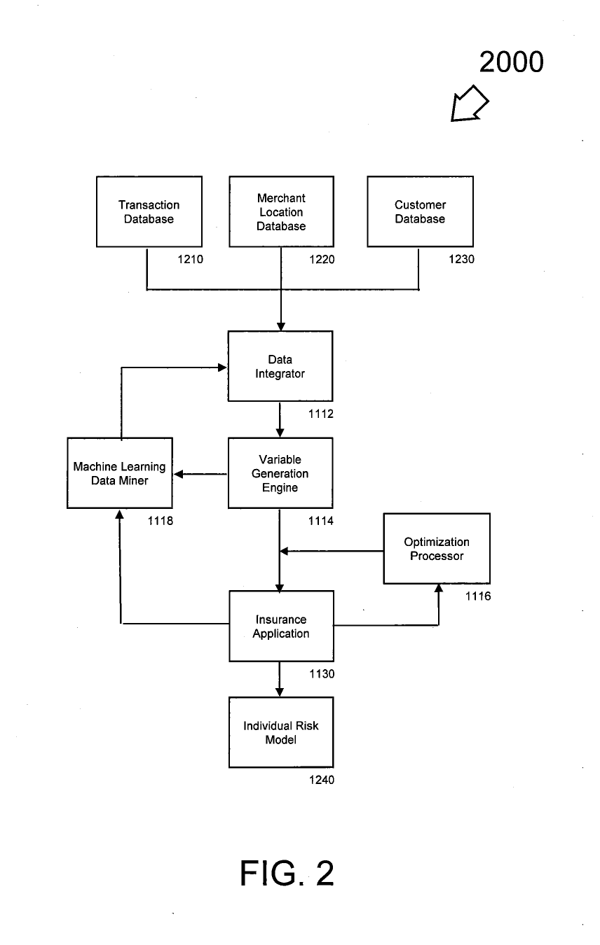

It is understood by those familiar with the art that one or more of these databases 1210-1240 may be combined in a myriad of combinations. The function of these structures may best be understood with respect to the data flow diagram of FIG. 2, as described below.

We now turn our attention to the method or process embodiments of the present disclosure described in the data flow diagram of FIG. 2. It is understood by those known in the art that instructions for such method embodiments may be stored on their respective computer-readable memory and executed by their respective processors. It is understood by those skilled in the art that other equivalent implementations can exist without departing from the spirit or claims of the invention.

FIG. 2 is a data flow diagram of a risk assessment apparatus method 2000 to enable insurance-related risk behavior modeling of individuals based on their payment card purchases, constructed and operative in accordance with an embodiment of the present disclosure. The resulting individual risk model 1240 may be used in risk assessment to determine pricing for a variety of insurance application 1130 categories. These categories include, but are not limited to: life insurance, health insurance, automobile insurance, homeowners insurance, or any other types of insurance known in the art.

Method 2000 is a batch method that enables insurance-related risk behavior modeling of individuals based on their payment card purchases.

As shown in FIG. 2, data integrator 1112 receives data from a transaction database 1210, standardized risk database 1220, and cardholder database 1230. The data may be filtered by time range, depending upon data availability or desirability.

The cardholder's individual transaction data may come from a transaction database 1210, a cardholder database, 1230 or both. The cardholder's individual transaction data includes a transaction entry for each financial transaction performed with a payment card. Each transaction entry may include, but is not limited to: a transaction data, customer information (such as an anonymized customer account identifier, customer geography, customer type, and customer demographics), merchant details (name, geographic location, line of business, and filmographies), purchase channel (on-line versus in-store transaction), product or service stock-keeping unit (SKU), and transaction amount.

A standardized risk database 1220 provides external (non-financial transaction-based) data sources for risk evaluation. These sources may include a sample of cardholders with insurance ratings, claim metrics, profitability metrics, or other target variables that contribute to the risk analytics.

Data integrator 1112 provides the data to the variable generation engine 1114. Variable generation engine 1114 produces a variable layer with transaction attribute variables to support the risk analysis. Examples of such independent variable categories include, but are not limited to: merchant categorization (healthy versus unhealthy dining, medical categories, healthy versus unhealthy activities, life stage indicators, insurable property retailers), measures (frequency or total spend in any of the categories), or changes in behavior. Examples of dependent variable categories include, but are not limited to: profitability of customers, claims amounts, low risk versus high risk underwriting classes.

Statistical techniques are used to derive risk insights, based on transaction attribute variables.

For any insurance application 1130 with at least one transaction attribute of interest, Xᵢ(A; t, l) can denote a transaction attribute variable at transaction level belonging to an account A, by transaction time stamp t, and transaction location 1. For example, X can be payment amount or any transaction related attribute, and V_{A}(x) can be a summarized variable at the customer level which can be any function of original transaction attribute x for a given individual risk model 1240, designated as target T.

Once generated, the transaction attribute of interest is provided to the insurance application 1130 and the machine learning data miner 1118. The machine learning data miner 1118 receives inputs from both the variable generation engine 1114 and the insurance application 1130 to refine the individual risk model 1240. Machine learning data miner 1118 starts with dozens of attributes of the transaction data, and computes the implicit relationships of these attributes and the relationship of the attributes to the insurance application 1130. The machine learning data miner 1118 derives from or transforms these attributes to their most useful form, then selects the variables for the variable generation engine 1114.

Insurance application 1130 also feeds information to optimization processor 1116. The optimization process happens after the variables are created by modeling processes:

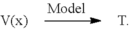

Optimization processor 1116 maximizes the correlation of the generated variables V with the target T by searching optimal mapping [symbol] and roll-up function [symbol] :

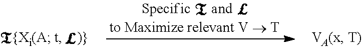

The searching space for the optimal mapping and functions is large, and the optimization processor 1116 may test the searching process with a limited domain. For example, one simplified approach is to fix the function dimension [symbol] = [symbol] , and searching the optimal mapping [symbol] .

In essence, the optimization processor 1116 learns from vast transactional data, explores target relevant data dimensions, and generates optimal customer level variable summarization rules automatically. The optimization processor 1116 is similar to the machine learning data miner 1118, but the difference is that optimization processor 1116 is working on the data that has been aggregated to the account level. The final individual risk model 1240 is implemented on each account for actions to be taken upon.

The optimization processor 1116 starts with selected variables (attributes) of each account (customer) and applies the statistical analysis to reduce the list of variables that appear to be related to various insurance ratings and outcomes based on the customer's transaction data. The optimization may be accomplished by computing the relationship of these variables to the insurance application 1130, and derives from or transforms these variables to their most useful form, applying the analytic phase to a broad universe of cardholders.

The feedback from optimization processor 1116 and machine learning data miner 1118 provides a machine learning approach for transactional data to customer risk optimization problems.

The previous description of the embodiments is provided to enable any person skilled in the art to practice the disclosure. The various modifications to these embodiments will be readily apparent to those skilled in the art, and the generic principles defined herein may be applied to other embodiments without the use of inventive faculty. Thus, the present disclosure is not intended to be limited to the embodiments shown herein, but is to be accorded the widest scope consistent with the principles and novel features disclosed herein.

What is claimed is:

1. A risk assessment method comprising:
receiving transaction data regarding a financial transaction, the transaction data including a transaction attribute;
generating, via a processor, a customer level target specific variable layer from the transaction data;
modeling, via the processor, cardholder behavior with the customer level target specific variable layer to create a risk model of cardholder behavior;
saving the risk model of cardholder behavior to a non-transitory computer-readable storage medium.

2. The risk assessment method of claim 1, wherein the transaction attribute includes a transaction account, a transaction time, and merchant details.

3. The risk assessment method of claim 2, the generating the customer level target specific variable layer comprises:
summarizing or averaging the transaction attribute at a customer level.

4. The risk assessment method of claim 3, wherein the risk model of cardholder behavior is used for underwriting.

5. The risk assessment method of claim 3, wherein the risk model of cardholder behavior is used for claims estimation.

6. The risk assessment method of claim 3, wherein the risk model of cardholder behavior is used for identification of life stages.

7. The risk assessment method of claim 3, wherein the risk model of cardholder behavior is used for identification of identifying inconsistencies.

8. A risk assessment apparatus comprising:
a processor configured to receive transaction data regarding a financial transaction, the transaction data including a transaction attribute, to generate, a customer level target specific variable layer from the transaction data, to model cardholder behavior with the customer level target specific variable; and
a non-transitory computer-readable storage medium to store the risk model of cardholder behavior.

9. The risk assessment apparatus of claim 8, wherein the transaction attribute includes a transaction account, a transaction time, and merchant details.

10. The risk assessment apparatus of claim 9, the generating the customer level target specific variable layer comprises:
summarizing or averaging the transaction attribute at a customer level.

11. The risk assessment apparatus of claim 10, wherein the risk model of cardholder behavior is used for underwriting.

12. The risk assessment apparatus of claim 10, wherein the risk model of cardholder behavior is used for claims estimation.

13. The risk assessment apparatus of claim 10, wherein the risk model of cardholder behavior is used for identification of life stages.

14. The risk assessment apparatus of claim 10, wherein the risk model of cardholder behavior is used for identification of identifying inconsistencies.

15. A non-transitory computer readable medium encoded with data and instructions, when executed by a computing device the instructions causing the computing device to:
receive transaction data regarding a financial transaction, the transaction data including a transaction attribute;
generate, via a processor, a customer level target specific variable layer from the transaction data;
model, via the processor, cardholder behavior with the customer level target specific variable layer;
store the risk model of cardholder behavior on a non-transitory computer-readable storage medium.

16. The non-transitory computer readable medium of claim 15, wherein the transaction attribute includes a transaction account, a transaction time, and merchant details.

17. The non-transitory computer readable medium of claim 16, the generating the customer level target specific variable layer comprises:
summarizing or averaging the transaction attribute at a customer level.

18. The non-transitory computer readable medium of claim 16, wherein the risk model of cardholder behavior is used for underwriting.

19. The non-transitory computer readable medium of claim 16, wherein the risk model of cardholder behavior is used for claims estimation.

20. The non-transitory computer readable medium of claim 16, wherein the risk model of cardholder behavior is used for identification of life stages.
